(19) United States
(12) Patent Application Publication
(10) Pub. No.: US 2023/0221111 A1
(43) Pub. Date: Jul. 13, 2023

(54) ACQUISITION DEVICE FOR A PARTIALLY AUTOMATED ACQUISITION OF MULTIPLE OBJECT DATA SETS OF AT LEAST ONE OBJECT

(71) Applicant: Robert Bosch GmbH, Stuttgart (DE)

(72) Inventors: Darno Alexander Ketterer, Renningen (DE); Seabastian Schmitt, Stuttgart (DE)

(21) Appl. No.: 18/002,230

(22) PCT Filed: Jun. 21, 2021
(86) PCT No.: PCT/EP2021/066780

§ 371 Date: Dec. 16, 2022

(30) Foreign Application Priority Data
Jun. 22, 2020 (DE) 10 2020 207 655.3

(51) Int. Cl. G01B 11/25; G01B 11/04

(52) U.S. Cl. CPC G01B 11/2518; G01B 11/04

(57) ABSTRACT

An acquisition device for the at least partially automated acquisition of multiple object data sets of at least one object. The acquisition device includes at least one object data acquisition unit for the acquisition of object data, at least one object carrier unit for arranging the object, and at least one reference unit that is at least provided to output, in particular optically output, a reference element for a size classification of the object.

### BACKGROUND INFORMATION

German Patent Application No. DE 10 2017 219 407 A1 describes an acquisition device for the at least partially automated acquisition of multiple object data sets of at least one object, including at least one object data acquisition unit for the acquisition of object data, and including at least one object carrier unit for arranging the object.

### SUMMARY

The present invention starts relates to an acquisition device for the at least partially automated acquisition of multiple object data sets of at least one object, including at least one object data acquisition unit for the acquisition of object data, and including at least one object carrier unit for arranging the object.

According to an example embodiment of the present invention, the acquisition device includes at least one reference unit that is at least provided to output, in particular optically output, a reference element for a size classification of the object. As a result, objects can advantageously be categorized particularly easily according to size. In addition, advantageously an operator can be enabled, at least starting from the object data of the object, to estimate and/or determine the size of the object.

According to an example embodiment of the present invention, the acquisition device preferably includes at least two object data acquisition units, in particular the object data acquisition unit and a further object data acquisition unit. The acquisition device preferably includes at least one guide unit provided to guide at least one object data acquisition unit. On the guide unit there are preferably arranged the two object data acquisition units, the guide unit particularly preferably including at least one, in particular at least partially curved, guide element. Preferably, one object data acquisition unit of the two object data acquisition units is arranged on the guide element, and the further object data acquisition unit of the two object data acquisition units is arranged on a further guide element of the guide unit, or the two object data acquisition units are arranged on the guide element on sides that face away from each other.

According to an example embodiment of the present invention, preferably, at least the two object data acquisition units are arranged on the guide unit separately from each other. In particular, at least one of the two object data acquisition units is arranged movably on the guide unit. The guide unit is provided in particular to guide at least one of the two object data acquisition units that is arranged on the guide unit upon movement, with preferably a defined path of movement of at least the one object data acquisition unit being specified using the guide unit. “Provided” is to be understood to mean in particular specifically set up, specifically designed, and/or specifically equipped. That an object is provided for a specific function is to be understood to mean in particular that the object fulfills and/or performs this particular function in at least one state of application and/or operating state. The guide unit is in particular provided at least to counteract a movement of one object data acquisition unit of the two object data acquisition units that is arranged on the guide unit along a direction that deviates from the defined path of movement. The guide unit may for example include at least a multi-axis robotic arm, an articulated arm, a swivel arm, and/or at least the guide element, particularly preferably a plurality of guide elements.

According to an example embodiment of the present invention, at least one of the two object data acquisition units is preferably arranged movably on the guide element. The guide element is preferably at least provided to guide at least the one object data acquisition unit that is arranged on the guide element upon movement. The guide element includes in particular at least one main guide track, with a defined path of movement of the at least one object data acquisition unit that is arranged on the guide element running at least parallel to the main guide track. Preferably, the guide element takes the form of a rail. Preferably, the main guide track of the guide element runs at least substantially parallel to a main longitudinal axis of the guide element. Preferably, the guide element, that in particular takes the form of a rail, includes at least one further main guide track, on which, in particular in at least one embodiment, the further object data acquisition unit of the two object data acquisition units can be arranged and/or moved. In particular, the main guide track and the further main guide track are arranged on the guide element on sides that face away from each other. Preferably, the main guide track runs parallel to the further main guide track.

According to an example embodiment of the present invention, preferably, the guide unit, in particular in at least one embodiment, comprises at least the guide element and the further guide element. It is possible for the further guide element to be configured identically to the guide element or differently than the guide element. Preferably, the guide element is configured separately from the further guide element, and/or at least arranged spaced apart from the further guide element. Particularly preferably, the guide element and the further guide element are arranged along a direction running at least substantially parallel to a surface of the object carrier unit of the acquisition device, at the same distance from the object carrier unit that is particularly preferably provided to position the object in an object data acquisition region of the acquisition device.

In particular, according to an example embodiment of the present invention, the two object data acquisition units are borne movably relative to each other, in particular along the guide unit. The two object data acquisition units are preferably movable independently of each other. Preferably, the two object data acquisition units, in particular separately from each other, can be arranged simultaneously at the same acquisition height on the guide unit, at least viewed along a main guide track of the guide element and/or a main guide track of the further guide element. It is also possible for at least the two object data acquisition units to be arranged on the main guide track of the guide element or on the further main guide track of the guide element. Preferably, at least one object data acquisition unit of the two object data acquisition units is arranged laterally on the guide element, at least viewed along a main guide track of the guide element, or on the further guide element, in particular laterally, at least viewed along a main guide track of the further guide element. One further object data acquisition unit of the two object data acquisition units, in particular in at least one embodiment, is preferably arranged laterally on the guide element, at least viewed along a main guide track of the guide element, or on the further guide element, in particular laterally, at least viewed along a main guide track of the further guide element. Particularly preferably, in particular in at least one embodiment, the object data acquisition unit and the further object data acquisition unit are arranged on sides of the guide element that face away from each other. Preferably, the path of movement defined by the guide unit runs in an at least partially curved and/or at least partially rectilinear manner: particularly preferably the defined path of movement runs in an arc of a circle. Preferably, the path of movement or the guide track forms an arc of a circle. In particular, the arc of a circle comprises a central angle of 90°, preferably of more than 90°, particularly preferably of more than 180°. It is also possible for the path of movement or the guide track to describe a complete circle. In particular, a center point of an arc of a circle of the at least partially curved path of movement or of the at least partially curved guide track defines a center point of an object data acquisition region that is provided to receive an object for acquisition. A “curvature” at a point of a path that is other than zero is to be understood in this connection to mean in particular a deviation, relative to a straight line, that grows quadratically with distance from the point of the path. The main guide track of the guide element runs in particular in an at least partially curved manner, it also being possible for the main guide track to run at least partially rectilinearly.

An “object data acquisition unit” is to be understood to mean in particular a unit that is provided at least for acquisition of one type of object data. Preferably, the object data acquisition unit is an imaging acquisition unit that comprises in particular a still picture camera and/or a moving picture camera.

Preferably, the object data acquisition unit includes a true-color camera. Alternatively, it is possible for the object data acquisition unit to comprise for example an infrared camera, a ToF camera, and/or the like. An object data set preferably comprises at least two, particularly preferably at least ten, different recordings by the object data acquisition unit. An “object data set” comprises in particular at least two different items of object data relating to the same object. A multiple object data set preferably comprises more than ten different items of object data, particularly preferably more than one hundred different items of object data, relating to the same object. Preferably, a multiple object data set comprises at least two different types of object data relating to the same object. “Object data” is to be understood to mean in particular an item of information that is suitable for characterizing an object, in particular for distinguishing it from a further object. Preferably, object data comprise characteristics inherent in an object. Object data may comprise in particular the appearance, shape, contour, color, symmetry, weight, material, and/or other characteristic that appears useful to a person skilled in the art. It is also possible for situation-related characteristics to be acquired, for example a relative arrangement in relation to a further object, in particular to a counter-piece, a degree of soiling, and/or a temporary marking. “Partially automated acquisition” is to be understood to mean in particular that at least one multiple object data set in at least one operating state is acquired in unmanned mode, i.e., in particular without the intervention of an operator.

Preferably, according to an example embodiment of the present invention, the acquisition device comprises at least one drive unit that is at least provided to produce a defined relative movement between at least one object data acquisition unit of the two object data acquisition units and the object. A “defined relative movement” is to be understood to mean in particular a relative change in the position and/or orientation that is actively controllable at least in a regular operating state of the acquisition device. In particular, the drive unit is provided to produce a defined relative movement between at least one object data acquisition unit of the two object data acquisition units and the object carrier unit. Preferably, the drive unit is provided to move at least that one object data acquisition unit of the two object data acquisition units that is arranged on the guide unit in an automated manner, in particular along the defined path of movement specified by the guide unit. In particular, the two object data acquisition units are movable independently of each other using the drive unit. In particular, object data can be acquired from multiple perspectives using the defined relative movement produced by the drive unit. A “perspective” is to be understood to mean in particular a specific relative arrangement, in particular position and/or orientation, of the object data acquisition unit and of the object, in particular of the object carrier unit. In particular, multiple perspectives comprise at least two different relative arrangements of the object data acquisition unit and of the object, in particular of the object carrier unit. Preferably, multiple perspectives comprise more than ten different arrangements of the object data acquisition unit relative to the object, in particular to the object carrier unit. In particular, two perspectives define an acquisition plane. Preferably, multiple perspectives comprise at least two different acquisition planes. Preferably, the entirety of all the acquisition planes possible with the drive unit are space-filling. Alternatively, a distance between two possible acquisition planes is at least less than 1 mm, and/or an angular distance between two possible acquisition planes is at least less than 1°. The drive unit is preferably an electromechanical one, and comprises in particular at least one electric motor, and/or for example at least one piezo element for fine adjustment. Alternatively, it is possible for the drive unit to be a pneumatic or hydraulic one. Preferably, at least one object data acquisition unit of the two object data acquisition units is mounted on a guide carriage of the guide unit, the guide carriage being arranged in particular movably on the guide element or on the further guide element. The further object data acquisition unit is particularly preferably mounted on a further guide carriage of the guide unit, the guide carriage being arranged in particular movably on the guide element or on the further guide element. Preferably, the guide carriage is configured separately from the further guide carriage. Particularly preferably, at least the guide carriage and/or the further guide carriage are/is configured with a movable receiving body to enable multidimensional movability, the receiving body, in particular using a ball and socket joint or the like, being arranged movably on a base body that cooperates with the guide element and/or the further guide element.

Preferably, according to an example embodiment of the present invention, the acquisition device comprises at least one main computing unit that is at least provided to carry out an object learning process. An “object learning process” is to be understood to mean in particular processing of the multiple object data sets for further use. For example, an object learning process may comprise the creation of a surround view of the object, the creation of a three-dimensional model of the object, and/or the extraction of characteristic features in particular for enabling pattern recognition. Preferably, the main computing unit is configured spatially separately from the drive unit and/or at least one object data acquisition unit of the two object data acquisition units. Preferably, the main computing unit takes the form of a server. Alternatively, it is possible for the main computing unit to be integrated in the object data acquisition unit. A “main computing unit” is to be understood to mean in particular a unit with an information input, an information processing means, and an information output. Preferably, the main computing unit includes at least a processor and a storage element. Particularly preferably, the components of the main computing unit are arranged on a common board, and/or most preferably arranged in a common housing. Preferably, the drive unit and/or at least one object data acquisition unit of the two object data acquisition units are/is controllable using the main computing unit. Preferably, the main computing unit controls at least the defined relative movement, in particular the movement of the two object data acquisition units relative to each other, and/or the movement of the guide element and of the further guide element relative to each other, and at least one acquisition time of at least one object data acquisition unit of the two object data acquisition units.

Preferably, according to an example embodiment of the present invention, the acquisition device includes at least one housing unit that is at least provided to shield an object data acquisition region at least partially from the outside. Preferably, at least the two object data acquisition units, the guide unit, and/or the drive unit are arranged at least partially in an interior defined by the housing unit. The housing unit is in particular provided to shield the interior from dust. Preferably, the housing unit shields the interior from electromagnetic radiation. Preferably, the housing unit comprises an, in particular single, aperture for positioning an object in the object data acquisition region. Particularly preferably, the acquisition device comprises at least one closure unit for in particular automatic closing and opening of the aperture. Preferably, the closure unit includes at least one closure element that may take the form of in particular a door or the like. The closure element is preferably movable relative to the aperture, in particular borne movably on the housing unit. It is possible for the closure element to be borne rotatably or linearly movably on the housing unit. The closure unit preferably includes at least one handle element that is arranged in particular on the closure element. In particular, a maximum length of the handle element, at least viewed along a main axis of extent of the handle element, extends at least substantially completely over a maximum extent of the closure element, at least viewed along an axis lying in a main plane of extent of the closure element. Advantageously, this can guarantee a high degree of operating comfort for a user when opening and closing the aperture. Advantageously, in addition operators of different body sizes can move the closure element with a high degree of comfort. A “main axis of extent” of an object is in this case to be understood to mean in particular an axis that runs parallel to a longest edge of a smallest geometric cuboid that still just completely encompasses the object. A “main plane of extent” of a structural unit or element is to be understood to mean in particular a plane that runs parallel to a largest side face of the smallest possible imaginary cuboid that still just completely encompasses the structural unit, and in particular runs through the center point of the cuboid. Furthermore, it is possible for the handle element to have a variable handle thickness, the handle thickness preferably being adjustable. Particularly preferably, the closure unit includes a damping element that is at least provided to brake the closure element in an end position and close it independently. Particularly preferably, a movement of the closure element, in particular closing and opening of the aperture using the closure element, is assisted by motor, preferably by an electric motor or the like. It is also possible for the opening and/or closing of the aperture using the closure element to be controllable, in particular automatically, by the main computing unit. Preferably, the closure unit includes at least one sealing element that is at least provided to seal off a region between the aperture and the closure element in a closed state, with at least the sealing element being arranged on and/or fastened to the closure element or the aperture. Advantageously, as a result at least a high degree of protection of the object data acquisition region from dust can be guaranteed.

According to an example embodiment of the present invention, the acquisition device comprises in particular at least one connection unit that is at least provided to connect at least the individual components of the acquisition device at least partially together, preferably electrically, and/or connect them to further units and/or elements. The connection unit may comprise in particular at least a compressed-air connection, a 400 V current connection, a 230 V current connection, a 230 V grounding contact with residual current device and grounding, an arc fault detection device (AFDD), a water connection for an extinguishing system, a media port (HDMI, VGA, DisplayPort, Lightning, and/or the like), an LAN port (gigabit LAN, gigabit glass fiber, and/or the like), a communication port (LTE module, 5G module, antenna, WLAN module, Bluetooth, NFC), a card reader, a connection for external scales, a communications port for an external robot, camera systems, weighing unit, USB 3.0 or higher for a keyboard, a barcode/QR code scanner, a mouse, a hard disk, a SATA port, an eSATA port, a collective port, a camera port, and/or the like that are preferably arranged at different positions on the acquisition device, in particular on the housing unit.

According to an example embodiment of the present invention, the connection unit is in particular at least provided, preferably at least using the LTE module and/or 5G module, to enable external access to the acquisition device. Preferably, at least remote maintenance of the acquisition device can be carried out through the external access. It is possible for at least one camera image from the acquisition device, in particular at least for remote maintenance, to be able to be transmitted using the connection unit. It is possible for the acquisition device, in particular the main computing unit, to be controllable at least partially through the external access using the connection unit. Particularly preferably, the external access to the acquisition device can be enabled and blocked using a hardware switch of the connection unit. Alternatively or additionally, it is possible for the external access to be at least password protected. Preferably, the connection unit comprises at least a connecting element for the external access that is formed separately, in particular for example using a VLAN, from further elements of the connection unit. It is possible for the connection unit to comprise at least a software firewall and/or a hardware firewall.

Furthermore, it is possible for the acquisition device to comprise at least one transport unit at least for transporting the acquisition device. Preferably, the transport unit is arranged on, in particular fastened to, the acquisition device, particularly preferably on/to the housing unit. Preferably, the transport unit includes at least one transport element, particularly preferably at least two, and most preferably at least four, transport elements, the transport elements being arranged in particular uniformly on one side on the housing unit of the acquisition device. The transport element may take the form for example of a roller, a chain, and/or the like. Preferably, at least the transport element is lockable, in order to at least counteract an unintentional movement of the acquisition device. In particular, it is possible for at least the transport element to be driven in order to produce a transport movement of the acquisition device, or in order at least to assist the transport movement of the acquisition device, the transport movement being controllable particularly preferably using a transport control unit. Preferably, the transport control unit may take the form of a remote control, the main computing unit, the mobile acquisition unit, or the like. It is also possible for the transport unit to include a receptacle that takes the form of a recess at least for a fork of a forklift truck and/or for connection to a crane, hook, or the like. Alternatively or additionally, it is possible for the transport unit to comprise a maneuvering aid that is configured in one piece with the housing unit of the acquisition device, or can be fastened releasably to the housing unit. Furthermore, it is possible for the transport unit to comprise a trailer coupling that is formed in particular in one piece with the housing unit or can be fastened releasably to the housing unit. The trailer coupling is particularly preferably arranged retractably on the housing unit.

According to an example embodiment of the present invention, preferably, the reference unit is at least provided to output a reference element that assists at least one user in a size classification of the object. Preferably, the reference unit is at least provided, using the reference element, to enable at least one operator to estimate an object size, in particular at least starting from an object data set. Preferably, at least part of the object data set of the object includes a reference element for a size classification. Preferably, at least the part of the object data set that is not provided for the object learning process of the main computing unit includes the reference element. It is however also possible for the entire object data set to include the reference element. Alternatively or additionally, it is possible for the reference element to be able to be output and/or stored separately from the object data set. The reference unit may for example take the form of a projection unit, a laser unit, a computing unit, an augmented reality unit, or the like. The reference unit is preferably at least provided to output a reference element for a qualitative size classification of the object, particularly preferably for a quantitative size classification of the object. The reference element can be represented in particular as a scale, an object of comparison, for example a coin, or the like. It is possible for the reference element to be able to be output at least on the object, on the object carrier unit, and/or in the object data set. It is possible for the reference element, in particular in at least one embodiment, to be able to be acquired at least upon the acquisition of the object data using the object data acquisition units, and to be able to be added to the object data set. Preferably, the reference unit, in particular at least the reference unit that takes the form of a projection unit or laser unit, is at least provided to output, in particular optically output, the reference element in an object data acquisition region of the object carrier unit, preferably on the object carrier unit, particularly preferably on the surface of the object carrier unit, and/or on the object. As a result, advantageously the reference element can be output on the object carrier unit, the object carrier unit not needing to include an output means. Advantageously, it is possible to dispense with a physical reference element for size classification of the object.

In at least one example embodiment of the present invention, the reference unit preferably takes the form of an augmented reality unit, and in particular is at least provided to output the reference element as an augmented reality element, with a reference unit that takes the form of an augmented reality unit preferably comprising at least a camera and an output element. The output element may take the form for example of a monitor, a smartphone, a spectacle lens, or the like. Particularly preferably, the reference unit is at least provided to output the reference element on the output element. Advantageously, as a result a particularly flexible reference unit can be provided. Advantageously, in addition the reference element can be adapted particularly easily to different objects, and in particular be positioned particularly easily.

In at least one further embodiment of the present invention, the reference unit, which takes the form in particular of a computing unit, is preferably at least provided to assign the reference element to at least a part of the object data set after acquisition of the object data. Preferably, the reference unit is at least provided to incorporate the reference element, in particular digitally, in at least part of the acquired object data. It is alternatively or additionally possible for the reference element to be able to be stored in a file that is at least separate from the object data acquired using the object data acquisition units. Advantageously, as a result, a size classification of the object can take place independently of the object data acquisition. By digitally outputting the reference element, advantageously it is possible to dispense at least substantially with additional components for configuring a reference unit.

According to an example embodiment of the present invention, it is further provided that the reference element can be output by the reference unit at least dependent on at least one characteristic variable of the object. Advantageously, as a result, a reference element can be adapted to the object. In addition, advantageously, good visibility of the reference element can be guaranteed. Preferably, at least one characteristic of the reference element can be set dependent on the characteristic variable of the object. The characteristic of the reference element may for example be a position, a color, a shape, an intensity, or the like. The characteristic variable of the object may for example be a position, a dimension, a color, or the like. Preferably, the characteristic of the reference element can be set automatically using the main computing unit and/or the reference unit, it alternatively also being possible for the characteristic of the reference element to be able to be set manually by an operator. Preferably, in at least one embodiment, the reference element can be output dependent on a dimension and/or positioning of the object. It is possible for at least one characteristic variable of the object to be able to be acquired, in particular automatically, prior to acquisition of the object data and/or the outputting of the reference element. For example, at least one characteristic variable of the object can be acquired at least using a dimension acquisition unit and/or an identification unit. Preferably, the identification unit is provided at least for prior acquisition of at least one characteristic variable of the object, the identification unit taking the form for example of a scanning unit for reading in an identification element. The identification element may take the form for example of an EAN, a barcode, a QR code, an RFID tag, or the like. Preferably, at least the characteristic variable of the object can be retrieved from a database with the aid of the identification element. The identification element is preferably arranged on the object and/or integrated in the object. It is however also possible for the identification element to be arranged separately from the object, for example on packaging and/or a datasheet. A “dimension acquisition unit” is to be understood to mean in particular a unit that can acquire at least one extent and/or positioning of an object. Preferably, the dimension acquisition unit includes a movably borne laser module for a time-of-flight measurement. Alternatively, it is possible for an extent of an object to be able to be calculated, with a structure-from-motion method, using the main computing unit with the aid of the object data and movement data of the object carrier unit acquired using the object data acquisition units, in particular a speed of rotation. It is also possible for the “dimension acquisition unit” to comprise an illumination unit and a detection unit in order to obtain an extent from a transmitted light and/or incident light method. Preferably, at least the dimension acquisition unit and/or the identification unit are/is able to be connected by a data link to the main computing unit. It is also possible for a plurality of methods to be combined. Alternatively or additionally, it is also possible for at least the characteristic variable of the object to be able to be input manually by an operator.

Furthermore, according to an example embodiment of the present invention, it is provided that, using the reference unit, the reference element can be output at least at different positions on the object carrier unit and/or at different positions in the object data set. As a result, good visibility of the reference element can be guaranteed. Further, advantageously, undesirable superposition of the reference element and the object can be counteracted. Preferably, the reference element, in particular in at least one embodiment, can be output at any position whatsoever on the object carrier unit, preferably on the surface of the object carrier unit. Particularly preferably, an output direction of the reference unit, in particular at least of the reference unit that takes the form of a projection unit, can be set, with preferably the position of the reference element being able to be set by setting the output direction of the reference unit. Preferably, the output direction of the reference unit can be set at least by a relative movement, preferably tilting, of the reference unit relative to the object carrier unit. The relative movement between the reference unit and the object carrier unit is controllable in particular at least using the main computing unit and/or the reference unit, with at least the relative movement of the reference unit preferably being able to be produced at least using the drive unit. It is also possible for the relative movement to be able to be produced by an operator. Particularly preferably, the reference unit is movably, preferably pivotably, arranged on the guide unit. According to an example embodiment of the present invention, preferably, the reference unit, in particular at least the reference unit that takes the form of a projection unit, is arranged on the guide element of the guide unit. Additionally, it is possible for at least the reference unit that takes the form of an augmented reality unit to be arranged at least partially on the guide unit. It is however alternatively also possible for the reference unit to be arranged at least partially on the further guide element, or on a robotic arm of the guide unit. Preferably, the reference unit in at least one embodiment is arranged on and/or fastened to one of the object data acquisition units, with the object data acquisition unit being arranged in particular pivotably on the guide unit. In particular, by swiveling the object data acquisition unit on which the reference unit is arranged, either the object data acquisition unit can be used for acquisition of object data of the object, or the reference unit can be used for outputting the reference element onto the object carrier unit. Alternatively, it is possible for the reference unit to be arranged on the guide unit separately from the object data acquisition units. In at least one further embodiment, a position of the reference element in the object data set can be set, preferably using the reference unit, in particular at least using a reference unit that takes the form of a computing unit or an augmented reality unit. Preferably, at least the reference unit that takes the form of an augmented reality unit is formed at least partially by the object data acquisition unit. The object data acquisition unit is preferably at least provided to acquire the object data acquisition region for outputting the reference element in the object data set. Preferably, a reference element can be produced using the main computing unit and/or a computing unit of the augmented reality unit in the object data acquisition region acquired using the object data acquisition unit. Preferably, the reference element can be produced independently of a position of the object data acquisition unit on the guide unit. Preferably, the reference element can be adapted to a position of the object data acquisition unit at least using the main computing unit and/or the computing unit of the augmented reality unit. The output element of the reference unit that takes the form of an augmented reality unit may at least be arranged for example on the acquisition device, preferably on an outer side of the housing unit of the acquisition device. It is also possible for the output element to be formed separately from the acquisition device and to be arranged as an external element, the output element being able to be connected in particular at least by a data link, by cable, or wirelessly, at least to the object data acquisition unit and/or the main computing unit. The output element is preferably at least provided to display the object data acquisition region acquired using the object data acquisition unit. The augmented reality unit is at least provided to produce the reference element at least in the object data acquisition region output on the output element.

Further, according to an example embodiment of the present invention, it is provided that the reference unit at least be provided to output at least one further reference element, the reference element and the further reference element being able to be output at different positions from each other on the object carrier unit and/or at different positions from each other in the object data set. Advantageously, as a result, particularly good visibility of the reference element for size classification can be guaranteed. All the reference elements can preferably be output on the object carrier unit, on the object, and/or in the object data set, in particular at any positions whatsoever in the object data set. Preferably, at least the reference unit that takes the form of a projection unit is at least provided to output the reference element on the object carrier unit or on the object. Preferably, at least the reference unit that takes the form of a projection unit is at least provided to output the further reference element on the object carrier unit or on the object. Preferably, at least the reference unit that takes the form of a projection unit is at least provided to output the reference element and the further reference element on two different sides, particularly preferably on two sides that face away from each other, of the object. It is additionally possible for the reference unit to be provided to output additional reference elements, with preferably one reference element in each case being able to be output at least using the reference unit that takes the form of a projection unit on at least two different sides, particularly preferably on at least four different sides, and most preferably on at least five different sides, of the object. At least the reference unit that in at least one embodiment takes the form of an augmented reality unit is at least provided to produce the reference element, the further reference element, and/or additional reference elements at least in the object data acquisition region acquired using the object data acquisition unit, and/or in the object data set. Preferably, at least the reference unit that takes the form of an augmented reality unit is at least set up to output all the reference elements in any way whatsoever at least within the acquired object data acquisition region.

Furthermore, according to an example embodiment of the present invention, it is provided for the reference unit, in particular in at least one example embodiment, to take the form of a projection unit, in particular the one already mentioned above, that is provided at least to output the reference element by a projection. Advantageously, as a result, the reference element can be output on the object carrier unit, the object carrier unit not needing to include an output means. Further, it is advantageously possible to dispense with a physical reference element for size classification of the object. The projection unit preferably includes at least one projector, preferably a plurality of projectors, that is/are at least provided to output all the reference elements. At least the projector can preferably be arranged, in particular movably, on the guide unit. It is possible for the projectors to be able to be arranged at different positions on the guide unit or at least to be able to be arranged, particularly preferably movably, partially spaced apart from the guide unit on the acquisition device. It is possible for the projection unit to be arranged at least partially at least on the guide element, on the further guide element, and/or on a robotic arm of the guide unit.

Further, it is provided that the reference unit, in particular in at least one embodiment of the present invention, at least assigns the reference element to the object data set after acquisition of the object data set. Advantageously, as a result, a size classification of the object can take place independently of the object data acquisition. By digitally outputting the reference element, in addition it is advantageously possible to dispense at least substantially with additional components for configuring a reference unit. In particular, at least the reference unit that takes the form of a computing unit is provided, at least starting from at least one characteristic variable of the object, to produce a reference element, the reference element possibly taking the form for example of an item of information in relation to a size classification of the object in a file. Preferably, the reference unit is at least provided to assign the reference element to the acquired object data set, the reference element preferably being stored in a file that is separate from the object data. Further, it is possible for at least the reference unit that takes the form of an augmented reality unit at least to be provided to store the reference element in a file separate from the acquired object data, the reference element being able to be assigned to the object data, in particular after acquisition of the object data.

Further, the present invention provides a method for the acquisition of multiple object data sets of at least one object, using an acquisition device according to the present invention. According to an example embodiment of the present invention, it is provided that in at least one method step a reference element be output by the reference unit. Advantageously, as a result objects can be categorized particularly easily according to size. Advantageously, in addition an operator can be enabled, starting from the object data of the object, to estimate and/or determine the size of the object. Preferably, at least in the method step, a reference element is output for a qualitative size classification of the object, particularly preferably for a quantitative size classification of the object. It is possible for the reference element, at least in the method step, to be output dependent on at least one characteristic variable of the object. Preferably, at least in the method step, at least one characteristic, in particular dependent on at least one characteristic variable of the object, is automatically set using the main computing unit and/or the reference unit. It is possible, at least in the method step, for a plurality of reference elements, preferably at least the reference element and the further reference element, to be output by the reference unit.

Furthermore, according to an example embodiment of the present invention, it is provided that the reference element, at least in the method step, be projected onto the object carrier unit and/or be at least partially output in the object data set. Advantageously, as a result it is possible to dispense with a physical reference element for size classification of the object.

According to an example embodiment of the present invention, the reference element, at least in the method step, is output on the object, on the object carrier unit, and/or at any position whatsoever in the object data set. Particularly preferably, the reference element, at least in the method step, is automatically positioned at least dependent on a dimension and/or positioning of the object on the object carrier unit, on the object, and/or in the object data set. In particular, at least the reference element and the further reference element, at least in the method step, are output at different positions, preferably at different positions on the object, on the object carrier unit, and/or in the object data set. Preferably, the two object data acquisition units, in at least one method step, are moved by the drive unit, with object data of the object being acquired at least by the two object data acquisition units at least from different perspectives. Preferably, the movement at least of the two object data acquisition units and the acquisition of object data, at least in the method step, are controlled by the main computing unit. Preferably, using the main computing unit, in particular based on advance acquisition of object parameters, operating parameters at least for the drive unit and at least the two object data acquisition units are automatically established. In particular, a list is drawn up with positions at least for the two object data acquisition units and the object carrier unit at which acquisition of object data at least using one object data acquisition unit of the two object data acquisition units, particularly preferably using the two object data acquisition units, takes place. Particularly preferably, in at least one method step, one object data acquisition unit of the two object data acquisition units, in particular at least the two object data acquisition units, and preferably also the object carrier unit, are/is controlled to the positions of the list, with object data of the object being acquired at the respective position at least using one object data acquisition unit of the two object data acquisition units, particularly preferably at least using the two object data acquisition units. Preferably, in particular in at least one embodiment, at least the reference element is at least partially acquired upon the acquisition of the object data.

Further, it is proposed that, at least in a method step, in particular in at least one embodiment of the present invention, the reference element be stored in a file, in particular a file different than the acquired object data set. As a result, advantageously a size classification of the object can be retrieved particularly easily. For categorization of objects according to size, it is possible to dispense with reading out the object data set: advantageously categorization of an object can be carried out particularly easily and rapidly at least according to size. Preferably, in at least one method step, at least using the reference unit that takes the form of a computing unit or the reference unit that takes the form of an augmented reality unit, a reference element is produced dependent on at least one characteristic variable of the object, with the reference element possibly taking the form for example of an item of information on a size classification of the object in a file. In at least one method step, the file comprising the reference element is assigned to the object data set of the object, with the object data set and the reference element being stored in separate files. It is possible, in at least one further method step, for a size classification of the object to be carried out by reading out the file including the reference element.

The acquisition device according to the present invention and/or the method according to the present invention should in this case not be restricted to the application and specific embodiments described above. In particular, the acquisition device according to the present invention and/or the method according to the present invention, in order to comply with a mode of operation described herein, may include a number, deviating from a number mentioned herein, of individual elements, components, and units, as well as method steps. In addition, in the case of the value ranges quoted in this disclosure, values lying within the aforementioned limits should also be deemed disclosed, and usable in any way whatsoever.

### BRIEF DESCRIPTION OF THE DRAWINGS

Further advantages of the present invention will become apparent from the following description of the figures. The figures illustrate two embodiments of the present invention. The figures and the description contain numerous features in combination. The person skilled in the art will expediently also consider the features individually and combine them to form useful further combinations, in view of the disclosure herein.

FIG. 1 shows a side view of an acquisition device according to the present invention in a schematic representation in a first variant.

FIG. 2 shows a schematic sequence of a method according to the present invention for the acquisition of multiple object data sets using the acquisition device according to the present invention in the first variant.

FIG. 3 shows a side view of an acquisition device according to the present invention in a schematic representation in a second variant.

### DETAILED DESCRIPTION OF EXAMPLE EMBODIMENTS

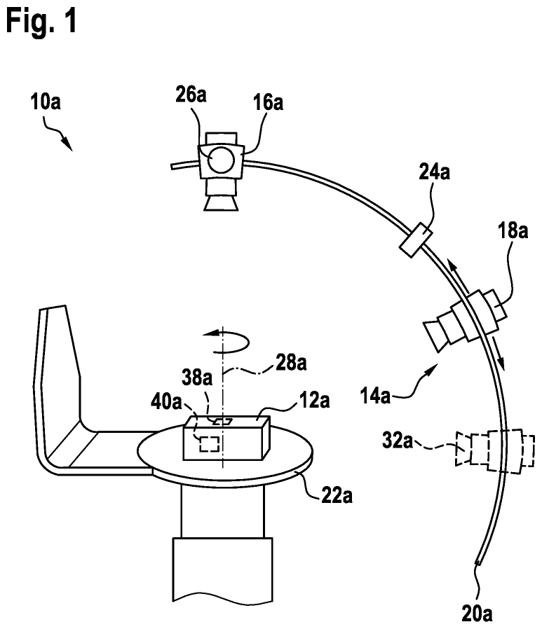

FIG. 1 shows a side view of an acquisition device 10a with a guide unit 14a for guiding at least one object data acquisition unit. The guide unit 14a includes a guide element 20a that takes the form of an at least partially curved rail. The acquisition device 10a includes at least two object data acquisition units 16a, 18a for the acquisition of object data of an object 12a, these object data acquisition units being arranged on the guide unit 14a. The two object data acquisition units 16a, 18a are arranged on the guide element 20a on sides that face away from each other. It is possible for further acquisition units 32a to be arranged on the guide unit 14a, in particular on the guide element 20a, these further acquisition units possibly taking the form for example of additional object data acquisition units, illumination units, contrast units, and/or the like. The two object data acquisition units 16a, 18a are arranged movably on the guide element 20a, the guide element 20a being at least provided to guide the two object data acquisition units 16a, 18a upon movement. The guide element 20a includes at least two main guide tracks, with a defined path of movement of the object data acquisition units 16a, 18a arranged on the guide element 20a running at least parallel to one of the two main guide tracks. One object data acquisition unit 16a of the two object data acquisition units 16a, 18a is arranged on the main guide track of the guide element 20a, and a further object data acquisition unit 18a is arranged on a further main guide track of the two main guide tracks of the guide element 20a. The main guide track and the further main guide track are arranged on the guide element 20a on sides that face away from each other, with the main guide track running parallel to the further main guide track.

The acquisition device 10a includes an object carrier unit 22a that is provided to position the object 12a in the object data acquisition region of the acquisition device 10a. A main plane of extent of the guide element 20a runs at right angles to a positioning plane of the object carrier unit 22a, and intersects an axis of rotation 28a of the object carrier unit 22a.

The two object data acquisition units 16a, 18a are movable relative to each other, in particular independently of each other, and can be arranged on the guide unit 14a simultaneously and in particular separately from each other at the same acquisition height, at least viewed along one main guide track of the two main guide tracks of the guide element 20a. The acquisition device 10a comprises at least one drive unit (not illustrated in greater detail) that is at least provided to produce a defined relative movement between the two object data acquisition units 16a, 18a and the object 12a. The drive unit is provided at least to produce a defined relative movement between the two object data acquisition units 16a, 18a and the object carrier unit 22a. The drive unit is provided to move the two object data acquisition units 16a, 18a in an automated manner along the defined path of movement specified by the guide unit 14a. Object data can be acquired from multiple perspectives using the defined path of movement produced by the drive unit. The drive unit may for example be an electromechanical one, the drive unit having at least one electric motor. Alternatively, it is possible for the drive unit to be a pneumatic or hydraulic one. The object data acquisition units 16a, 18a are each mounted on a guide carriage (not illustrated in greater detail) of the guide unit 14a, the guide carriages being configured separately from each other and arranged movably on the guide unit 14a. It is possible for the guide carriages, to enable multidimensional movability, to be configured with a movable receiving body that, in particular using a ball and socket joint or the like, is arranged movably on a base body that cooperates with the guide element 20a.

The guide unit 14a includes at least one delimiting element 24a for dividing the main guide track of the guide element 20 into at least two movement regions along the main guide track that are separate from each other. The delimiting element 24a is fastened to the main guide track of the guide element 20a. It is possible for the delimiting element 24a to be able to be arranged variably at least along the main guide track of the guide element 20a. It is additionally possible for the guide unit 14a to include further delimiting elements that can be arranged on the guide unit 14a.

The acquisition device 10a includes at least one reference unit 26a that is at least provided to output, in particular optically output, a reference element 38a for size classification of the object 12a. The reference unit 26a is at least provided, using the reference element 38a, to enable at least one operator to estimate an object size, at least starting from an object data set. The reference unit 26a takes the form of a projection unit. The reference element 38a may be represented in particular as a scale, an object of comparison, for example a coin, or the like. The reference element 38a, at least upon the acquisition of the object data, can be acquired using the object data acquisition units 16a, 18a, and can be added to the object data set. The reference unit 26a is at least provided to optically output the reference element 38a in an object data acquisition region of the object carrier unit 22a, preferably on the object carrier unit 22a, particularly preferably on the surface of the object carrier unit 22a, and/or on the object 12a.

The reference element 38a can be output by the reference unit 26a at least dependent on at least one characteristic variable of the object 12a. Preferably, at least one characteristic of the reference element 38a can be set dependent on the characteristic variable 12a of the object. The characteristic of the reference element 38a may for example be a position, a color, a shape, an intensity, or the like. The characteristic variable of the object 12a may for example be a position, a dimension, a color, or the like. It is possible for the characteristic of the reference element 38a to be able to be set automatically using the main computing unit and/or the reference unit 26a, it alternatively also being possible for the characteristic of the reference element 38a to be able to be set manually by an operator. The reference element 38a can be output at least dependent on a dimension and/or positioning of the object 12a. A characteristic variable of the object 12a can be acquired prior to acquisition of the object data and/or outputting of the reference element 38a, in particular automatically. For example, at least one characteristic variable of the object 12a can be acquired at least using a dimension acquisition unit (not illustrated in greater detail) and/or an identification unit (not illustrated in greater detail). Preferably, the identification unit is provided at least for prior acquisition of at least one characteristic variable of the object 12a, the identification unit taking the form for example of a scanning unit for reading in an identification element. The identification element may take the form for example of an EAN, a barcode, a QR code, an RFID tag, or the like. Preferably, at least the characteristic variable of the object 12a can be retrieved from a database with the aid of the identification element. The identification element is preferably arranged on the object 12a and/or integrated in the object 12a. It is however also possible for the identification element to be arranged separately from the object 12a, for example on packaging and/or a datasheet. A “dimension acquisition unit” is to be understood to mean in particular a unit that can acquire at least an extent and/or positioning of an object 12a. Preferably, the dimension acquisition unit includes a movably borne laser module for a time-of-flight measurement. Alternatively, it is possible for an extent of an object 12a to be able to be calculated, using a structure-from-motion method, with the main computing unit with the aid of the object data and movement data of the object carrier unit 22a acquired using the object data acquisition units 16a, 18a, in particular a speed of rotation. It is also possible for the “dimension acquisition unit” to comprise an illumination unit and a detection unit in order to obtain an extent from a transmitted light and/or incident light method. Preferably, at least the dimension acquisition unit and/or the identification unit are/is able to be connected by a data link to the main computing unit. It is also possible for a plurality of methods to be combined. Alternatively or additionally, it is also possible for at least the characteristic variable of the object 12a to be able to be input manually by an operator.

The reference element 38a can be output at least at different positions on the object carrier unit 22a using the reference unit 26a. The reference element 38a can be output at any position whatsoever on the object carrier unit 22a, in particular on the surface of the object carrier unit 22a. An output direction of the reference unit 26a can be set, with the position of the reference element 38a being able to be set by setting the output direction of the reference unit 26a. The output direction of the reference unit 26a can be set at least by a relative movement, preferably tilting, of the reference unit 26a relative to the object carrier unit 22a. The relative movement between the reference unit 26a and the object carrier unit 22a is controllable at least using the main computing unit and/or the reference unit 26a, with at least the relative movement between the reference unit 26a and the object carrier unit 22a being able to be produced at least using the drive unit. It is also possible for the relative movement to be able to be produced by an operator. The reference unit 26a is arranged movably, preferably pivotably, on the guide element 20a of the guide unit 14a.

The reference unit 26a is at least provided to output at least one further reference element 40a, with the reference element 38a and the further reference element 40a being able to be output at different positions from each other on the object carrier unit 22a. All the reference elements can be output on the object carrier unit 22a and/or on the object 12a. The reference unit 26a is at least provided to output the reference element 38a on the object carrier unit 22a or on the object 12a. The reference unit 26a is at least provided to output the further reference element 38a on the object carrier unit 22a or on the object 12a. Preferably, at least the reference unit 26a is at least provided to output the reference element 38a and the further reference element 40a on two different sides, particularly preferably on two sides that face away from each other, of the object 12a. It is additionally possible for the reference unit 26a to be provided to output additional reference elements, with preferably in each case a reference element 38a being able to be output at least using the reference unit 26a on at least two different sides, particularly preferably on at least four different sides, and most preferably on at least five different sides, of the object 12a. It is possible for the reference unit 26a developed as a projection unit to include at least one projector, preferably a plurality of projectors, that is/are at least provided to output all the reference elements. The projectors may for example be arranged, preferably movably, at different positions on the guide unit 14a, or at least be arranged on the acquisition device 10a partially spaced apart from the guide unit 14a. Alternatively, it is at least also possible for the reference unit 26a to take the form of a laser unit.

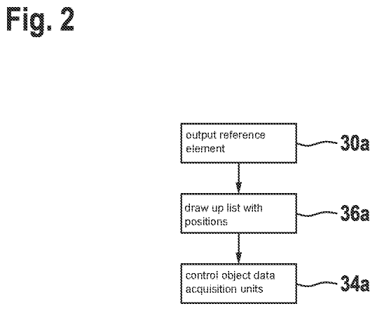

FIG. 2 shows schematically a sequence of a method for the acquisition of multiple object data sets of the object 12a with the acquisition device 10a.

In at least one method step 30a, the reference element 38a that is provided for an order of magnitude (size classification) of the object 12a is output using the reference unit 26a. At least in the method step 30a, the reference element 38a is output for a qualitative size classification of the object 12a or a quantitative size classification of the object 12a. At least in the method step 30a, the reference element 38a is output at least dependent on at least one characteristic variable of the object 12a. It is possible, at least in the method step 30a, for at least one characteristic to be set automatically, in particular dependent on at least one characteristic variable of the object 12a, using the main computing unit and/or the reference unit 26a. It is possible, at least in the method step 30a, for a plurality of reference elements to be output by the reference unit 26a. At least in the method step 30a, at least the reference element 38a and the further reference element 40a are output and projected onto the object carrier unit 22a. Particularly preferably, the reference element 38a, at least in the method step 30a, is positioned automatically at least dependent on a dimension and/or a positioning of the object 12a on the object carrier unit 22a and/or on the object 12a. At least the reference element 38a and the further reference element 40a, at least in the method step 30a, are output at different positions, preferably at different positions on the object 12a and/or on the object carrier unit 22a.

It is alternatively or additionally possible for, at least in the method step 30a, the reference element 38a to be stored in a file, in particular one different than the acquired object data set.

In at least one method step 34a, the two object data acquisition units 16a, 18a are moved on the guide element 20a along the guide element 20a on sides that face away from each other. In the method step 34a, the object data acquisition unit 16a is moved in one of the movement regions delimited by the delimiting element 24a for acquisition of a multiple object data set. Using the main computing unit, in particular based on advance acquisition of object parameters, operating parameters are automatically established at least for the drive unit and at least the two object data acquisition units 16a, 18a in at least one method step 36a. In the method step 36a, a list is drawn up with positions at least for the object data acquisition units 16a, 18a and the object carrier unit 22a at which acquisition of object data takes place using the object data acquisition units 16a, 18a. In the method step 34a, at least the object data acquisition units 16a, 18a and the object carrier unit 22a are controlled to the positions of the list, with object data of the object 12a being acquired at the respective position in the method step 34a at least using one of the object data acquisition units 16a, 18a. The reference element 38a is at least partially acquired upon the acquisition of the object data using the object data acquisition units 16a, 18a.

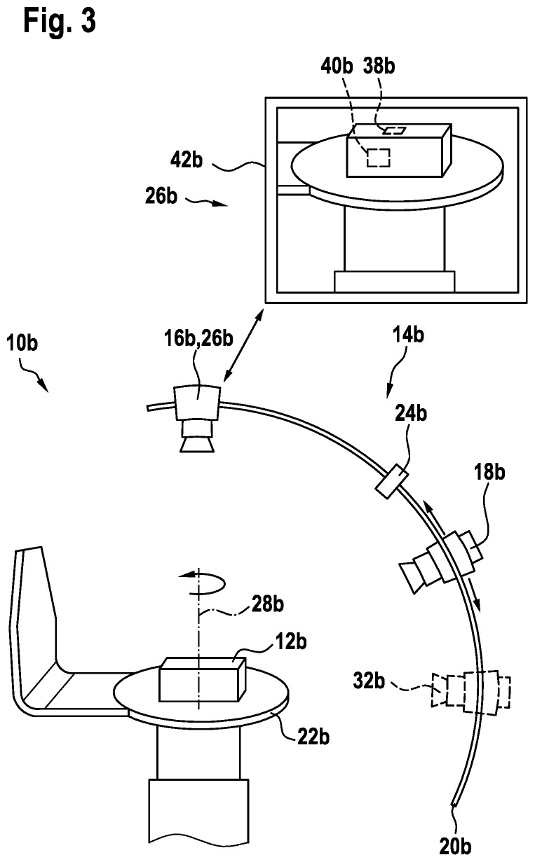

FIG. 3 shows a further embodiment of the invention. The following descriptions and the drawings are restricted essentially to the differences between the embodiments, with, regarding components of identical designation, in particular in relation to components with identical reference numerals, it also being generally possible to make reference to the drawings and/or the description of the other embodiments, in particular FIGS. 1 and 2. To distinguish the embodiments, the letter a is appended to the reference numeral of the embodiment in FIGS. 1 and 2. In the embodiment of FIG. 3, the letter a is replaced by the letter b. In particular, the methods relating to the further embodiments take place analogously to the method described hitherto, the methods being able to be distinguished by the described differences from the embodiment described hitherto in relation to technical configurations of the acquisition devices of the further embodiments.

FIG. 3 shows an acquisition device 10b for the at least partially automated acquisition of multiple object data sets of at least one object 12b, including at least one object data acquisition unit 16b for the acquisition of object data, and including at least one object carrier unit 22b for arranging the object 12b. The acquisition device 10b includes at least one reference unit 26b that is at least provided to output a reference element 38b for size classification of the object 12b. The reference unit 26b takes the form of an augmented reality unit that is at least provided to output the reference element 38b as an augmented reality element. The reference unit 26b is formed at least partially by the object data acquisition unit 16b. The object data acquisition unit 16b is at least provided to acquire the object data acquisition region for outputting the reference element 38b in the object data set. In the object data acquisition region acquired using the object data acquisition unit 16b, a reference element 38b can be produced using the main computing unit and/or a computing unit of the augmented reality unit. Preferably, the reference element 38b can be produced independently of a position of the object data acquisition unit 16b on a guide unit 14b. The reference element 38b can at least be adapted to a position of the object data acquisition unit 16b relative to the object carrier unit 22b using the main computing unit and/or the computing unit of the augmented reality unit.

The reference unit 26b comprises an output element 42b that takes the form of a monitor. It is also possible for the output element 42b to take the form of a smartphone, a spectacle lens, or the like. The output element 42b of the reference unit 26b that takes the form of an augmented reality unit may be arranged for example on the acquisition device 10b, preferably on an outer side of the housing unit of the acquisition device 10b. It is also possible for the output element 42b to be configured separately from the acquisition device 10, and to be arranged as an external element, the output element 42b being able to be connected in particular at least by a data link, by cable, or wirelessly, at least to the object data acquisition unit 16b and/or the main computing unit. The output element 42b is preferably at least provided to display the object data acquisition region acquired using the object data acquisition unit 16b. The augmented reality unit is at least provided to produce the reference element 38b at least in the object data acquisition region output on the output element 42b.

The reference element 38b can be output using the reference unit 26b at least at different positions in the object data set, in particular in the object data acquisition region acquired using the object data acquisition unit 16b. The reference unit 26b is at least provided to output at least one further reference element 40b, with the reference element 38b and the further reference element 40b being able to be output at different positions from each other in the object data set. It is also possible for the reference unit 26b to assign the reference element 38b to the object data set after acquisition of the object data set, with the reference element 38b being able to be stored in particular in a file that is separate from the acquired object data.

Alternatively, it is at least also possible for the reference unit 26b to take the form of a computing unit. The reference unit 26b assigns a reference element 38b to the object data set after the acquisition of the object data set. The reference unit 26b is at least provided, starting from at least one characteristic variable of the object 12b, to produce the reference element 38b, the reference element 38b possibly taking the form of an item of information on a size classification of the object 12b in a file. Further, it is possible for the reference unit 26b to be at least provided to assign the reference element 38b to the acquired object data set, with the reference element 38b preferably being stored in a file that is separate from the object data.

1-9. (canceled)

10. An acquisition device for the at least partially automated acquisition of multiple object data sets of at least one object, comprising:
at least one object data acquisition unit configured to acquire object data of the object; and
at least one object carrier unit configured to arrange the object;
at least one reference unit configured to optically output a reference element for a size classification of the object.

11. The acquisition device as recited in claim 10, wherein the reference unit is configured to output the reference element at least dependent on at least one characteristic variable of the object.

12. The acquisition device as recited in claim 10, wherein using the reference unit, the reference element can be output at least at different positions on the object carrier unit and/or at different positions in an object data set including the acquired object data.

13. The acquisition device as recited in claim 10, wherein the reference unit is configured to output at least one further reference element, the reference element and the further reference element being able to be output at different positions from each other on the object carrier unit and/or at different positions from each other in an object data set including the acquired object data.

14. The acquisition device as recited in claim 10, wherein the reference unit is a projection unit that is configured to output the reference element by a projection.

15. The acquisition device as recited in claim 10, wherein the reference unit at least assigns the reference element to the object data set after acquisition of the object data set.

16. A method for acquiring multiple object data sets of at least one object using an acquisition device including at least one object data acquisition unit configured to acquire object data of the object, and at least one object carrier unit configured to arrange the object; at least one reference unit configured to optically output a reference element for a size classification of the object, the method comprising:
outputting, by the reference unit, the reference element.

17. The method as recited in claim 16, wherein the outputting includes: projecting the reference element onto the object carrier unit and/or at least partially outputting the reference element in the object data set.

18. The method as recited in claim 16, further comprising:
storing the reference element in a file different than a file storing the acquired object data.
